(19) United States
(12) Patent Application Publication
(10) Pub. No.: US 2014/0255118 A1
(43) Pub. Date: Sep. 11, 2014

(54) Gear Cutting Machine with Double Machining Head

(71) Applicant: Liebherr-Verzahntechnik GmbH, Kempten (DE)

(72) Inventor: Thomas ZELLER, Kempten (DE)

(73) Assignee: Liebherr-Verzahntechnik GmbH, Kempten (DE)

(21) Appl. No.: 14/199,604

(22) Filed: Mar. 6, 2014

(30) Foreign Application Priority Data
Mar. 7, 2013 (DE) 10 2013 003 964.9

(51) Int. Cl. B23F 17/00

(52) U.S. Cl. CPC B23F 17/006
USPC 409/40

(57) ABSTRACT

A gear cutting machine includes a slide, which can be moved in a first direction, and at least two cutting heads, which are mounted on the slide. The cutting heads are mounted on the slide in such a way that they can be moved, independently of each other, in a second direction, and each of the cutting heads includes a motor spindle for receiving a cutting tool.

This application claims priority to patent application no. 10 2013 003 964.9, filed in Germany on Mar. 7, 2013, the entire disclosure of which is incorporated herein by reference.

### BACKGROUND OF THE INVENTION

The present invention relates to a gear cutting machine with a twin cutting head and two motor spindles for receiving in each case one cutting tool for hard finishing, in particular, for milling and grinding, for producing dissimilar geometries of gear teeth. In this case the gear cutting machine is designed to produce single and double helical gear teeth or also standard gear teeth, such as straight and helical teeth in large gear tooth systems.

In order to produce gear teeth, such as, for example, single and double helical gear teeth, there are a large number of known machining methods, such as, for example, shaping with a pinion cutter, planing, grinding, and in particular, milling. Hence, profile milling cutters can be used for one or both flanks. These profile milling cutters comprise the profile tool that already has the profile to be produced; or it is possible to use cylindrical tools, in which case the tooth profile is not detectable until during the machining process.

One advantage of machining with profile tools is that the teeth or the tooth flanks of the teeth can be completely finished in one step, after the material in the teeth spaces has been previously removed. In contrast, when cylindrical tools are used, the spaces have to be generated first by means of several envelop cuts. This procedure is more time consuming than a method that uses profile tools.

The advantage of cylindrical tools lies in the fact that they are an easily available standard tool, whereas in theory profile milling cutters have to be provided or produced anew for each tooth. It is even possible to correct the tooth profile with cylindrical tools at any time during the manufacturing process.

In the above context the manufacture of gear teeth, primarily large gear tooth systems in small batch sizes, using the milling method with profile tools and also with cylindrical tools entails a relatively complex process, in which both the workpiece that is to be machined and also the tool that is used are moved in a controlled manner in several directions. A suitable gear cutting machine with the typical procedure, in which, on the one hand, the workpiece is rotated not only about a longitudinal axis, but can also be moved linearly along this longitudinal axis and, on the other hand, the tool is both rotated about an axis of rotation and is also moved linearly, carries out a time-consuming manufacturing operation that is disadvantageous because of the plurality of envelop cuts that are necessary with cylindrical tools. In contrast, profile tools are often not an alternative because of the need to change the tool for a brief period of time, most of all, for large gear tooth systems, owing to the long production and delivery times inherent with these profile tools, since they have to be made for the corresponding gear tooth profiles.

### SUMMARY OF THE INVENTION

One object of the present invention is to further develop a gear cutting machine of the genre described in the introductory part of the specification in an advantageous way, so that faster machining times are made possible, and even halving these machining times is possible.

The present invention achieves this object by way of a gear cutting machine with a slide, which can be moved in a first direction, and at least two cutting heads, which are mounted on the slide. The cutting heads are mounted on the slide in such a way that the cutting heads can be moved, independently of each other, in a second direction. The cutting heads include motor spindles, each of which receives at least one cutting tool.

In this context the cutting tools can comprise, for example, milling cutters, grinding tools, drilling machines, turning tools, hob peeling machines, or face milling cutters. At the same time, each of the cutting heads exhibits an axis of rotation of the tools, about which the cutting heads can be rotated in the well-known way in order to carry out a metal cutting process. A gear cutting machine that is constructed in this way allows, in an advantageous way, not only the simultaneous use of both cutting heads, but also the successive use of both cutting heads in order to machine a workpiece. In the ideal case, such an arrangement makes it possible to achieve twice the cutting speed without simultaneously having to double the number of gear cutting machines or all of the components of the gear cutting machine. Since the second cutting head uses, according to the invention, components of the gear cutting machine that are shared with the first cutting head, it is possible to use these twice used components of the gear cutting machine more effectively. That means that in the ideal case it is possible for the cutting heads to use these components in parallel and to cut the machining times in half.

For this purpose, the first traversing direction of the slide may be a vertical direction, so that the slide can be moved upwards and downwards. However, in general, all directions are also conceivable, depending on the requirement. For example, horizontally mounted gear cutting machines may have slides that can be moved horizontally and, as a result, the first direction may be a horizontal direction.

In one exemplary embodiment, in which the first direction is a vertical direction, it is conceivable that the second direction, in which the cutting heads can be moved independently of each other, is a horizontal direction. Such a feature is advantageous because the cutting heads can be moved into the maximum possible number of different positions; as a result, the maximum possible bandwidth of different geometries of the workpiece can be produced.

For this purpose one preferred exemplary embodiment provides, in addition, that the cutting heads are mounted on the slide in such a way that they can be moved, independently of each other, in the first direction.

This arrangement enlarges in an advantageous way the bandwidth of the production operations that may be considered for producing the geometries of the workpiece. In one exemplary embodiment, in which the first direction is a vertical direction, the cutting heads can be used, for example, to simultaneously machine the workpiece at different heights of the workpiece.

Furthermore, in an additional preferred exemplary embodiment it is possible to have the cutting heads mounted on the slide in such a way that they can be moved, independently of each other, in a third direction.

As a result, this arrangement can further increase in an advantageous way the bandwidth of the production operations that may be considered for producing the geometries of the workpiece. In one exemplary embodiment, in which the first direction is a vertical direction and the second direction is a first horizontal direction, the third direction may then be a second horizontal direction. If, therefore, the cutting heads can be moved, independently of each other, along the second horizontal direction, then these cutting heads can also attack at different points on the workpiece in this direction.

Furthermore, it is possible, according to an additional exemplary embodiment, to have the cutting heads arranged parallel to each other.

As a result, the control of the parallel cutting heads can be simplified in an advantageous way, because now these cutting heads can be configured to carry out the machining operations in parallel. It is no longer necessary to provide different machining operations for the different cutting heads.

In another preferred exemplary embodiment it is possible to mount the cutting heads on the slide in such a way that they can be pivoted about other axes than the axes of rotation of the tools. In this case it is advantageous for these cutting heads to be mounted in such a way that they can be pivoted both parallel to each other and also non-parallel to each other. Such a pivotable arrangement of the cutting heads further increases in an advantageous way the bandwidth of the production operations that may be considered for producing the geometries of the workpiece.

For this purpose it is conceivable in an even more highly preferred exemplary embodiment to mount the cutting heads separately in such a way that they can be pivoted in the horizontal and/or vertical direction.

The separately pivotable arrangement, in which the cutting heads can be pivoted in the horizontal and vertical direction, represents one possible example of the design of the gear cutting machine, or more specifically its cutting heads. The cutting heads can also be arranged in such a way that they can be pivoted in other planes without departing from the inventive idea.

Hence, the described design of the gear cutting machine permits the cutting heads to attack simultaneously or alternatingly at two flanks of different teeth or at one flank or at two flanks of the same tooth.

This feature also permits an increase in the bandwidth of the geometries of the workpiece that can be produced by the gear cutting machine and an increase in the bandwidth of the production processes that can be represented by the gear cutting machine.

At the same time it is possible to configure the cutting heads for receiving cutting tools, in particular for milling tools, such as spherical milling cutters, end milling cutters, and/or profile milling cutters.

Since it is advantageous if different cutting heads can be used in a flexible way, the present invention is not limited to a specific milling process, but rather includes any and all conceivable milling processes that can be carried out in a meaningful way by two cutting heads that are coupled according to the invention. Furthermore, it is also possible that two different cutting heads are coupled to each other according to the invention; as a result, two different milling processes can also be carried out in parallel or offset in time by the gear cutting machine.

In an additional exemplary embodiment, it is possible that the gear cutting machine can be combined with a conventional machine tool for milling and turning, and/or combined with a conventional gear cutting machine for milling, shaping with a pinion cutter, and grinding.

Therefore, it is advantageously guaranteed that the present invention can be integrated as an additional machining step or as an additional machining possibility inside a milling arrangement known from the prior art. The present invention further develops this known milling arrangement in an inventive and advantageous way.

Additional details and advantages of the invention are explained in detail below by way of the exemplary embodiments shown in the figures.

### BRIEF DESCRIPTION OF THE DRAWINGS

FIG. 1 is an oblique view of a milling machine according to the state of the art.

FIG. 2 is an oblique view of a milling machine with a twin cutting head.

FIGS. 3a, 3b, and 3c show various milling tools.

FIGS. 4a, 4b, and 4c show various engagement possibilities of the milling tools.

### DETAILED DESCRIPTION OF THE INVENTION

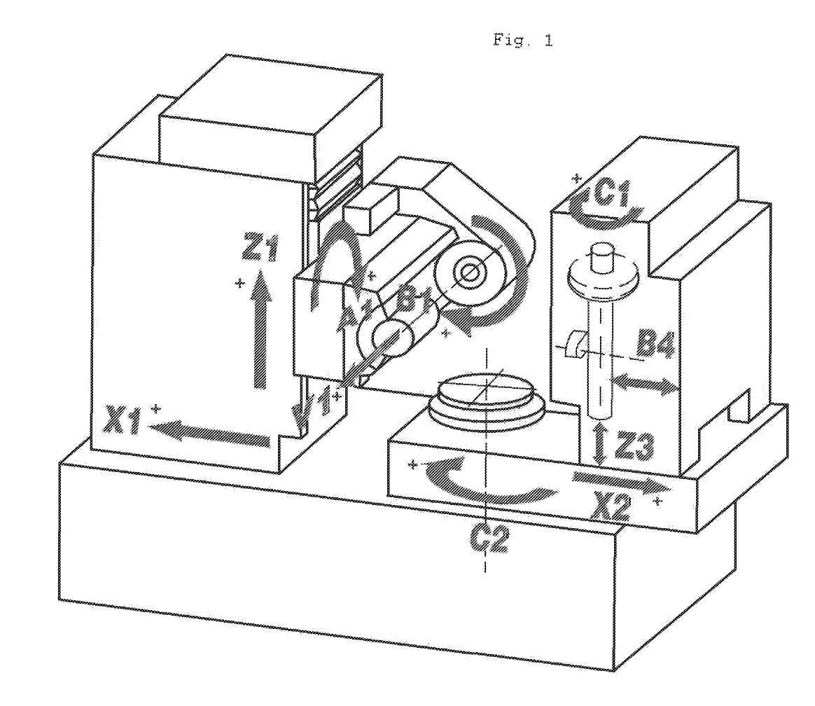

FIG. 1 shows a milling machine according to the state of the art. This prior art milling machine has a cutting head for machining a workpiece that is not illustrated.

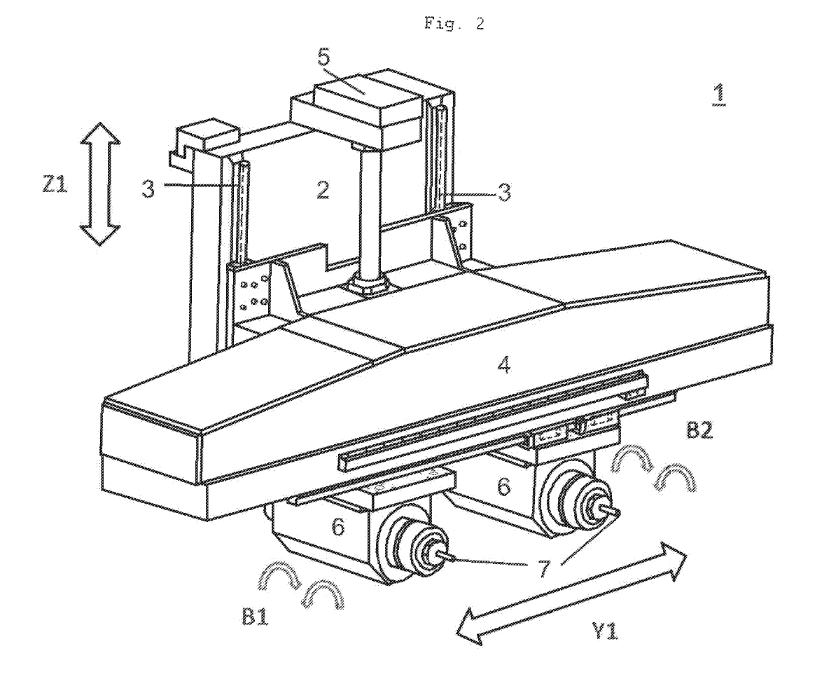

FIG. 2 shows a gear cutting machine 1, in which a slide 4 is arranged on a support section 2, on which the slide can be moved. The support section 2 and the slide 4 can be coupled to each other, for example, as shown in FIG. 2, by way of rails 3 and a drive device 5 in such a way that the support section and the slide can be moved relative to each other. In the exemplary embodiment that is shown, the slide 4 and the support section 2 can be moved relative to each other in a vertical direction Z1.

Two cutting heads 6 are provided on the slide 4. In the exemplary embodiment that is shown, these two cutting heads can be moved in relation to each other in a second horizontal direction Y1 along the slide 4. The cutting heads 6 can have different cutting tools 7.

At the same time the cutting heads 6 can drive the cutting tools 7 about the axes of rotation B1 and B2 of their tools and can, thus, accomplish the machining of a workpiece 10 that is depicted in the following figures.

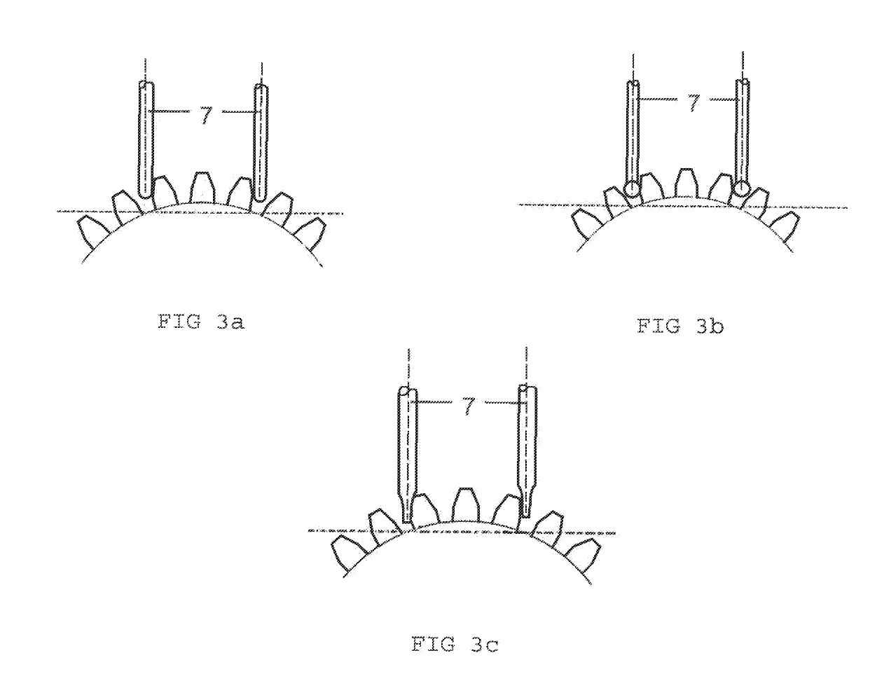

FIGS. 3a to 3c show three pairs of different cutting tools 7, which are in engagement with a workpiece 10. In this case the cutting tools 7 are, for example, cylindrical tools with rounded ends (FIG. 3a), spherical (FIG. 3b tools, and profile tools (FIG. 3c). These figures show the bilateral engagement of the cutting tools 7. In the exemplary embodiments shown in FIGS. 3a to 3c, the pairs of cutting tools 7 are arranged parallel to each other.

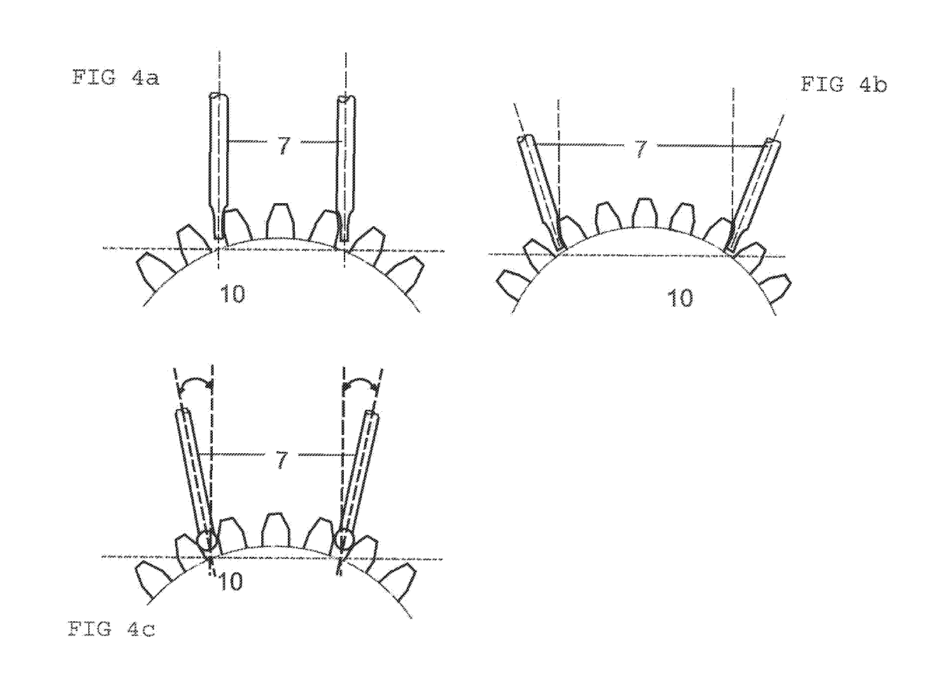

FIGS. 4b to 4c show, in contrast to FIG. 4a, exemplary embodiments in which the pairs of cutting tools 7 are not arranged parallel during a machining process. In this case the exemplary embodiment in FIG. 4a is an example of a 0° milling operation, whereas FIGS. 4b and 4c show a milling operation in which the cutting tools 7 are inclined in relation to each other by no more than 30°.

In this context, FIG. 4b shows profile tools, which are arranged in such away that they are angled in relation to each other and in this way carry out a machining process at the workpiece 10. FIG. 4c shows a pair of spherical end milling cutters, which are in a mutually angled engagement with a workpiece 10 that is to be machined.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A gear cutting machine comprising:
a slide, which can be moved in a first direction, and
at least two cutting heads, which are mounted on the slide,
wherein the cutting heads are mounted on the slide in such a way that they can be moved, independently of each other, in a second direction, and
wherein the cutting heads include motor spindles, in each of which at least one cutting tool is receivable.

2. The gear cutting machine as claimed in claim 1, wherein the cutting heads are mounted on the slide in such a way that they can be moved, independently of each other, in the first direction.

3. The gear cutting machine as claimed in claim 1, wherein the cutting heads are mounted on the slide in such a way that they can be moved, independently of each other, in a third direction.

4. The gear cutting machine as claimed in claim 1, wherein the cutting heads are arranged parallel to each other.

5. The gear cutting machine as claimed in claim 1, wherein the cutting heads are mounted on the slide in such a way that they are pivotable about axes other than axes of rotation of their cutting tools.

6. The gear cutting machine as claimed in claim 1, wherein the cutting heads are mounted separately in such a way that they are pivotable in at least one of the horizontal and vertical directions.

7. The gear cutting machine as claimed in clamp 1, wherein the cutting heads attack simultaneously or alternatingly at two flanks of different teeth of a workpiece or at one flank or two flanks of the same tooth of a workpiece.

8. The gear cutting machine as claimed in claim 1, wherein the cutting heads are configured for receiving any of cutting tools, milling tools, spherical milling cutters, end milling cutters, and/or profile milling cutters.

9. The gear cutting machine as claimed in claim 1, wherein the gear cutting machine is combinable with a known machine tool for milling and turning, with known a gear cutting machine for milling, shaping with a pinion cutter, and grinding, or with both such a machine tool and such a gear cutting machine.

10. The gear cutting machine as claimed in claim 2, wherein the cutting heads are mounted on the slide in such a way that they can be moved, independently of each other, in a third direction.

11. The gear cutting machine as claimed in claim 2, wherein the cutting heads are arranged parallel to each other.

12. The gear cutting machine as claimed in claim 2, wherein the cutting heads are mounted on the slide in such a way that they are pivotable about axes other than axes of rotation of their cutting tools.

13. The gear cutting machine as claimed in claim 2, wherein the cutting heads are mounted separately in such a way that they are pivotable in at least one of the horizontal and vertical directions.

14. The gear cutting machine as claimed in claim 2, wherein the cutting heads attack simultaneously or alternatingly at two flanks of different teeth of a workpiece or at one flank or two flanks of the same tooth of a workpiece.

15. The gear cutting machine as claimed in claim 2, wherein the cutting heads are configured for receiving any of cutting tools, milling tools, spherical milling cutters, end milling cutters, and/or profile milling cutters.

16. The gear cutting machine as claimed in claim 2, wherein the gear cutting machine is combinable with a known machine tool for milling and turning, with known a gear cutting machine for milling, shaping with a pinion cutter, and grinding, or with both such a machine tool and such a gear cutting machine.

17. The gear cutting machine as claimed in claim 3, wherein the cutting heads are arranged parallel to each other.

18. The gear cutting machine as claimed in claim 3, wherein the cutting heads are mounted on the slide in such a way that they are pivotable about axes other than axes of rotation of their cutting tools.

19. The gear cutting machine as claimed in claim 3, wherein the cutting heads are mounted separately in such a way that they are pivotable in at least one of the horizontal and vertical directions

20. The gear cutting machine as claimed in claim 3, wherein the cutting heads attack simultaneously or alternatingly at two flanks of different teeth of a workpiece or at one flank or two flanks of the same tooth of a workpiece.
